(19) United States
(12) Patent Application Publication
(10) Pub. No.: US 2025/0373897 A1
(43) Pub. Date: Dec. 4, 2025

(54) METHOD, APPARATUS, DEVICE AND MEDIUM FOR INFORMATION INTERACTION

(71) Applicant: Beijing Youzhuju Network Technology Co., Ltd., Beijing (CN)

(72) Inventor: Li Jia, Beijing (CN)

(21) Appl. No.: 19/220,454

(22) Filed: May 28, 2025

(30) Foreign Application Priority Data
May 28, 2024 (CN) 202410675072.X

(51) Int. Cl. H04N 21/466; H04N 21/431

(52) U.S. Cl. CPC H04N 21/4668; H04N 21/431

(57) ABSTRACT

According to embodiments of the disclosure, a method, an apparatus, a device and a medium for information interaction are provided. The method includes: in response to detecting an information entry request for a target service, presenting a service information entry interface corresponding to the target service, where the service information entry interface includes a plurality of entry items respectively corresponding to a plurality of types of service information; obtaining at least one entry prompt respectively associated with at least one of the plurality of entry items, where the at least one entry prompt is determined by using a machine learning model based on at least one of: feature information associated with the target service, and service recommendation information corresponding to a service type to which the target service belongs; and presenting the at least one entry prompt in association with the at least one entry item.

### CROSS-REFERENCE

The present application claims priority to Chinese Patent Application No. 202410675072.X, filed on May 28, 2024 and entitled “METHOD, APPARATUS, DEVICE AND MEDIUM FOR INFORMATION INTERACTION”, the entirety of which is incorporated herein by reference.

### FIELD

Example embodiments of the present disclosure generally relate to the field of computer technologies, and in particular, to a method, apparatus, a device and a computer-readable storage medium for information interaction.

### BACKGROUND

The Internet provides access to a wide variety of resources. For example, applications, products, audio and video content, and the like may be accessed through the Internet. In addition, content delivery and service promotion through the Internet have become a new form of information dissemination and are widely used. A recommendation system (e.g., an advertisement system) supports generating a service information entry interface based on a configuration of a content provider, and receiving service information provided by a service provider (e.g., an advertiser) via the service information entry interface. For example, the recommendation system may generate recommended content (e.g., an advertisement) based on the received service information, and provide the recommended content to a user.

### SUMMARY

In a first aspect of the present disclosure, a method for information interaction is provided. The method includes: in response to detecting an information entry request for a target service, presenting a service information entry interface corresponding to the target service, the service information entry interface comprising a plurality of entry items respectively corresponding to a plurality of types of service information; obtaining at least one entry prompt respectively associated with at least one of the plurality of entry items, the at least one entry prompt being determined by using a machine learning model based on at least one of: feature information associated with the target service, and service recommendation information corresponding to a service type to which the target service belongs; and presenting the at least one entry prompt in association with the at least one entry item.

In a second aspect of the present disclosure, an apparatus for information interaction is provided. The apparatus includes: an interface presenting module configured to in response to detecting an information entry request for a target service, present a service information entry interface corresponding to the target service, the service information entry interface comprising a plurality of entry items respectively corresponding to a plurality of types of service information; a prompt obtaining module configured to obtain at least one entry prompt respectively associated with at least one of the plurality of entry items, the at least one entry prompt being determined by using a machine learning model based on at least one of: feature information associated with the target service, and service recommendation information corresponding to a service type to which the target service belongs; and a prompt presenting module configured to present the at least one entry prompt in association with the at least one entry item.

In a third aspect of the present disclosure, an electronic device is provided. The electronic device includes: at least one processor; and at least one memory coupled to the at least one processor and storing instructions executable by the at least one processor, the instructions, when executed by the at least one processor, causing the electronic device to perform the method according to the first aspect of the present disclosure.

In a fourth aspect of the present disclosure, a computer-readable storage medium is provided, on which a computer program is stored, where the computer program, when executed by a processor, causes the processor to implement the method according to the first aspect of the present disclosure.

According to a fifth aspect of the present disclosure, a computer program product is provided, including a computer program, where the computer program, when executed by a processor, implements the method according to the first aspect of the present disclosure.

It should be understood that the content described in this Summary section is not intended to limit the key or important features of the embodiments of the present disclosure, nor is it intended to limit the scope of the present disclosure. Other features of the present disclosure will become easily comprehensible through the following description.

### BRIEF DESCRIPTION OF THE DRAWINGS

The above and other features, advantages and aspects of embodiments of the present disclosure will become more apparent when taken in conjunction with the drawings and with reference to the following detailed description. In the drawings, the same or similar reference numerals refer to the same or similar elements, where:

FIG. 1 shows a schematic diagram of an example environment in which embodiments of the present disclosure can be implemented;

FIG. 2 shows a flowchart of a signaling flow for information interaction according to some embodiments of the present disclosure;

FIG. 3 shows a schematic diagram of an example of a service information entry interface according to some embodiments of the present disclosure;

FIG. 4 shows a schematic diagram of an example of information interaction according to some embodiments of the present disclosure;

FIG. 5 shows a flowchart of a method for information interaction according to some embodiments of the present disclosure;

FIG. 6 shows a schematic structural block diagram of an apparatus for information interaction according to some embodiments of the present disclosure; and

FIG. 7 shows a block diagram of an electronic device in which one or more embodiments of the present disclosure can be implemented.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. Rather, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

In this document, unless explicitly stated, performing a step “in response to A” does not mean that the step is performed immediately after “A”, but may include one or more intermediate steps.

It may be understood that the data involved in the technical solution of the present application (including but not limited to the data itself, the acquisition or use of the data) should comply with requirements of corresponding laws, regulations and relevant provisions.

It may be understood that before using the technical solutions disclosed in various embodiments of the present disclosure, users should be informed of the type, scope of use, usage scenario, etc. of the personal information involved in the present disclosure in an appropriate manner according to relevant laws and regulations, and the authorization of the users should be obtained.

For example, in response to receiving an active request from a user, prompt information is sent to the user to explicitly prompt the user that the operation requested to be performed will require acquisition and use of the personal information of the user, so that the user can autonomously select whether to provide the personal information to software or hardware such as an electronic device, an application, a server, or a storage medium that performs the operation of the technical solution of the present disclosure according to the prompt information.

As an optional but non-limiting implementation, a manner of sending prompt information to the user in response to receiving the active request from the user may be, for example, a pop-up window, and the prompt information may be presented in the pop-up window in a text manner. In addition, the pop-up window may also carry a selection control for the user to select “agree” or “disagree” to provide the personal information to the electronic device.

It may be understood that the above process of notifying and obtaining the user's authorization is only illustrative, and does not constitute a limitation on the implementations of the present disclosure. Other methods that satisfy relevant laws and regulations may also be applied to the implementations of the present disclosure.

As used herein, the term “model” may learn an association relationship between a corresponding input and an output from training data, so that after the training is completed, a corresponding output may be generated for a given input. The generation of the model may be based on a machine learning technology. Deep learning is a machine learning algorithm that processes an input and provides a corresponding output by using a plurality of processors. A neural network model is an example of a model based on deep learning. In this document, a “model” may also be referred to as a “machine learning model”, a “learning model”, a “machine learning network” or a “learning network”, and these terms are used interchangeably herein.

A “neural network” is a machine learning network based on deep learning. The neural network is capable of processing an input and providing a corresponding output, and usually includes an input layer and an output layer and one or more hidden layers between the input layer and the output layer. A neural network used in deep learning applications usually includes many hidden layers, thereby increasing the depth of the network. The layers of the neural network are connected in sequence, so that an output of a previous layer is provided as an input of a subsequent layer, where the input layer receives an input of the neural network, and an output of the output layer is used as a final output of the neural network. Each layer of the neural network includes one or more nodes (also referred to as processing nodes or neurons), and each node processes an input from an upper layer.

Generally, machine learning may include three stages, that is, a training stage, a testing stage and an application stage (also referred to as an inference stage). In the training stage, a given model may be trained using a large amount of training data, and parameter values may be updated iteratively until the model can obtain consistent inferences that satisfy an expected target from the training data. Through training, the model may be considered to be able to learn an association (also referred to as an input-to-output mapping) from an input to an output from the training data. Parameter values of the trained model are determined. In the testing stage, a test input is applied to the trained model to test whether the model can provide a correct output, thereby determining the performance of the model. The testing stage may sometimes be incorporated into the training stage. In the application or inference stage, the trained model may be used to process an actual model input based on the obtained parameter values, to determine a corresponding model output.

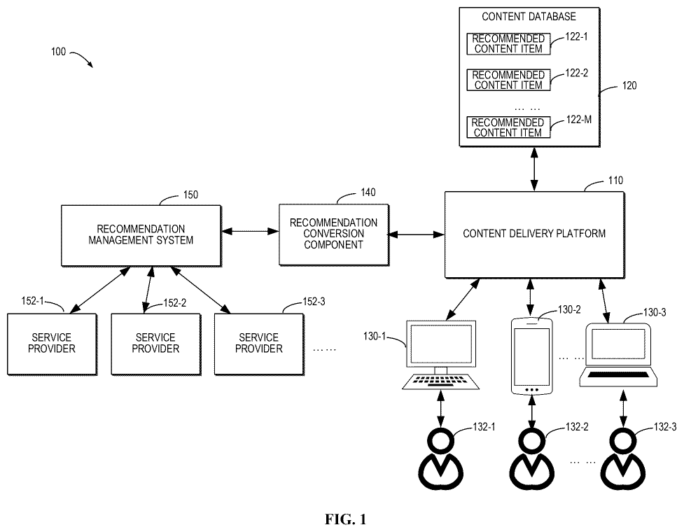

FIG. 1 shows a schematic diagram of an example environment 100 in which embodiments of the present disclosure can be implemented. One or more content providers may use a recommendation management system 150 to manage content to be delivered on a content delivery platform 110. One or more client devices 130-1, 130-2, 130-3, etc. (collectively or individually referred to as the client device 130 for case of discussion) are associated with the content delivery platform 110, and may access various types of content provided on the content delivery platform 110, for example, based on respective users 132-1, 132-2, 132-3, etc. (collectively or individually referred to as the user 132 for case of discussion). As an example, the content delivery platform 110 may be an application, a website, a web page, and other accessible platforms. The client device 130 may be installed with an application for accessing the content delivery platform 110, or may access the content delivery platform 110 in a suitable manner. The content delivery platform 110 may be configured to deliver one or more specific recommended content items (e.g., provide or present on the client device 130) related to one or more services to a user population based on a corresponding policy. The recommended content item to be delivered may include, for example, one or more recommended content items 122-1, 122-2, . . . 122-M (collectively or individually referred to as the recommended content item 122 for case of discussion) in the content database 120.

In this document, the service may include various recommendable objects, examples of which may include an application, a physical product/service, a virtual product/service, a digital content/physical content, and the like. In this document, a “recommended content item” refers to content presented to recommend a corresponding service. An example of the recommended content item may include an advertisement. In this document, the user population may include one or more user members, for example, the user 132. The user member may be any potential consumer of the service, such as a user, a group, an organization, an entity, and the like.

In some embodiments, the content delivery platform 110 may distribute the corresponding recommended content item 122 to the user 130 based on a request from a service provider 152-1, 152-2, 152-3, etc. (collectively or individually referred to as the “service provider” 152). In the scenario of advertisement delivery, the service provider is sometimes also referred to as an advertiser. In some embodiments, the recommended content item for being presented to a specific client device 130 in a content display opportunity (e.g., at a specific time and a specific location) of the content delivery platform 110 may be selected based on a bidding result. For example, a bid may be received from a service provider, and the content display opportunity is allocated to the highest bidder, which means that the corresponding recommended content item may be successfully delivered in a competitive delivery. A bid may refer to a cost to be spent on competitively delivering a certain recommended content item in a certain content display opportunity.

In some embodiments, the service provider 152 may also pay the provider of the content delivery platform 110 based on the presentation of the recommended content item and subsequent conversions. The recommendation conversion component 140 is configured to collect a conversion result of the user 132 on the recommended content item. The conversion result of the recommended content item may include viewing, clicking, downloading, paying, adding to cart, etc. of the recommended content item, and the specific conversion behavior is related to the recommended service and the service provider.

In some embodiments, the recommended content item 122 may be related to a form capable of collecting information. This type of recommended content item is sometimes also referred to as a form advertisement. In this way, by presenting the form, form information collection may be performed within the platform. The form advertisement may be used to invite users to subscribe to the service, provide a service evaluation, answer follow-up service introduction, receive information from the service provider, and the like. The form submission, that is, the information collected through the form, may also be determined by the recommendation conversion component 140 as the conversion result of the recommended content item.

In the environment 100, the recommendation management system 150 may be configured to deliver a recommended content item related to a form. In some embodiments, form information collected through the delivered form may be stored. The recommendation management system 150 may provide the collected form information to an information demander based on an information request from the service provider 152. In some embodiments, the service provider may also include a service provider that requests to deliver the recommended content item, or may be another information demander.

In some embodiments, the recommendation management system 150 may further provide the service provider 152 with a service information entry interface for receiving the service information, and receive the service information entered by the service provider 152 via the service information entry interface. For example, the recommendation management system 150 may determine the recommended content item to be delivered based on the service information.

In the environment 100, the client device 130 may be any type of mobile terminal, stationary terminal or portable terminal, including mobile phones, desktop computers, laptop computers, notebook computers, netbook computers, tablet computers, media computers, multimedia tablets, personal communication system (PCS) devices, personal navigation devices, personal digital assistants (PDA), audio/video players, digital cameras/camcorders, positioning devices, television receivers, radio broadcast receivers, e-book devices, game devices or any combination thereof, including accessories and peripherals of these devices or any combination thereof. In some embodiments, the client device 130 may also support any type of interface for users (such as “wearable” circuits, etc.).

In the environment 100, the content delivery platform 110, the recommendation conversion component 140 and/or the recommendation management system 150 may be, for example, various types of computing systems/servers capable of providing computing power, including but not limited to mainframes, edge computing nodes, computing devices in cloud environments, and the like. Although shown separately, one or more of the content delivery platform 110, the recommendation conversion component 140 and/or the recommendation management system 150 may be combined.

It should be understood that the components and arrangements in the environment shown in FIG. 1 are merely examples, and the computing system suitable for implementing the example embodiments described in the present disclosure may include one or more different components, other components and/or different arrangements.

Traditionally, when service providers enter service information via a service information entry interface, they often enter the service information based on their own understanding and preference. This may result in inaccurate or poor quality of the entered service information, which in turn leads to poor recommended content items determined based on the service information.

According to embodiments of the present disclosure, an improved solution for information interaction is provided. According to this solution, in response to detecting an information entry request for a target service, a service information entry interface corresponding to the target service is presented, where the service information entry interface includes a plurality of entry items respectively corresponding to a plurality of types of service information. At least one entry prompt respectively associated with at least one of the plurality of entry items is obtained, where the at least one entry prompt is determined by using a machine learning model based on at least one of: feature information associated with the target service, and service recommendation information corresponding to a service type to which the target service belongs. The at least one entry prompt is presented in association with the at least one entry item.

In this way, the entry prompt may be presented in association with the entry item on the service information entry interface, which facilitates the service provider to enter information more efficiently and accurately, and is helpful to improve the quality of the determined service information.

Some example embodiments of the present disclosure will be described below with continued reference to the drawings.

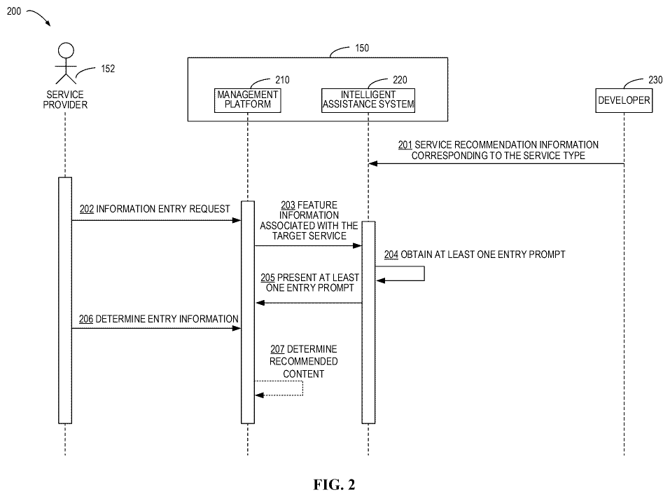

FIG. 2 shows a flowchart of a signaling flow 200 for information interaction according to some embodiments of the present disclosure. For ease of discussion, the signaling flow 200 is described with reference to FIG. 1. As shown in 200, the signaling flow 200 involves a recommendation management system 150, a service provider 152, and a developer 230. It is to be understood that it is only for discussion to discuss in conjunction with the recommendation management system 150, but it should be understood that the embodiments of the present disclosure may be implemented in any suitable device or system.

The recommendation management system 150 may at least include a management platform 210 and an intelligent assistance system 220. Note that the different components are distinguished here only for the purpose of discussion, according to functions. The different components may be implemented in software, hardware, firmware, and any combination thereof. In practical applications, these components may also be divided in any other suitable manner.

In some embodiments, the intelligent assistance system 220 may obtain (201) service recommendation information corresponding to a service type input by the developer 230. The type here may be a service division performed based on characteristics of the supplied service according to any suitable criteria. For example, different types may be divided according to the industry to which the service belongs, or the type of the service may be divided according to a larger or smaller granularity. Taking the division of types according to the industry as an example, the intelligent assistance system 220 may acquire service recommendation information respectively corresponding to a plurality of industries input by the developer 230.

In some embodiments, the service recommendation information may at least indicate adjustment information for the service type in the content delivery platform 110 for recommending the target service. Taking the division of types according to the industry as an example, the service recommendation information may indicate adjustment information of the service recommendation information corresponding to each industry in the content delivery platform. The adjustment information may indicate, for example, information such as a saturation degree and a conversion degree.

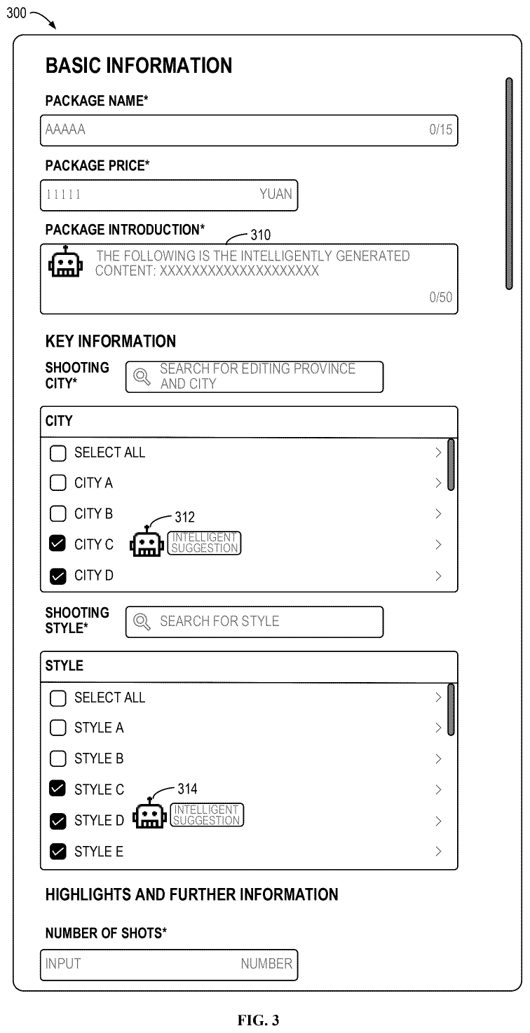

The management platform 110 in the recommendation management system 150 may receive (202) an information entry request from the service provider 152. For example, the management platform 110 may determine that the information entry request is received in response to receiving an access operation of the service provider 152 on the service information entry interface. The management platform 110 may present a service information entry interface corresponding to the target service in response to detecting the information entry request for the target service. The service information entry interface may include a plurality of entry items corresponding to a plurality of types of service information, respectively. Referring to FIG. 3, FIG. 3 shows a schematic diagram of an example 300 of a service information entry interface according to some embodiments of the present disclosure. The example 300 may be, for example, a service information entry interface corresponding to a photography service. The example 300 may include entry items such as a package name, a package price, a package introduction, a shooting city, a shooting style, a number of shots, and the like. It may be understood that the example 300 may also include more entry items.

In some embodiments, the service information entry interface is generated based on an interface template corresponding to a service type of the target service. In the embodiments of the present disclosure, interface templates are predefined according to types for services of different service types. When a viewing request of a client device for a service information entry interface of a certain service is detected, an interface template corresponding to the service will be retrieved. The target interface template is used to define a structured interface format for information related to the target service type. In this way, for the target service type, the interface layout may be designed according to the characteristics of the service under the service type. By configuring the interface template, the service information entry interfaces corresponding to different categories of services may be standardized and unified, which is beneficial to highlighting the characteristics of different services, so that users can enter useful information related to the service more quickly. In some embodiments, the target interface template at least includes a definition of key-value pairs for information related to the target category and key information in the key-value pairs. In this way, the service information corresponding to the target service will be filled with value information in the key-value pairs.

The intelligent assistance system 220 may obtain (203) the feature information associated with the target service from the management platform 210. The feature information may be extracted by the management platform 210 from information received via the service information entry interface, or may be obtained by the management platform 210 from a client device of the service provider 152 with an authorization of the service provider 152, or may be obtained by means of a database, a search engine, etc. The present disclosure does not limit the specific manner in which the management platform 210 obtains the feature information.

The feature information associated with the target service may include, for example, feature information for characterizing the service provider 152 of the target service. Taking the service provider 152 as a merchant as an example, the feature information associated with the target service may include feature information of the merchant, and the feature information of the merchant may include, for example, information such as a merchant name, a location, and a level. The feature information associated with the target service may also include, for example, feature information for characterizing a service recipient of the target service. Taking the target service as photography as an example, the service recipient may be a photographed user, and the service provider may be a photographer or a photography store. The feature information for characterizing the service recipient of the target service may include, for example, information such as an age, a preference, and a city of the photographed user. The feature information associated with the target service may also include, for example, feature information for characterizing a service type to which the target service belongs. Taking the division of the service type according to the industry as an example, the feature information for characterizing the service type to which the target service belongs may include, for example, description information of the industry to which the target service belongs.

The intelligent assistance system 220 may obtain (204) at least one entry prompt associated with at least one of the plurality of entry items, respectively. The at least one entry prompt may be determined by the intelligent assistance system 220 using a machine learning model. For example, the intelligent assistance system 220 may determine the at least one entry prompt by using the machine learning model based on at least one of: the feature information associated with the target service and/or the service recommendation information corresponding to the service type to which the target service belongs. For example, the intelligent assistance system 220 may construct a prompt input based on the feature information associated with the target service and/or the service recommendation information corresponding to the service type to which the target service belongs. The intelligent assistance system 220 may provide the prompt input to the trained machine learning model, and obtain a model output for the prompt input output by the machine learning model, where the model output may include the at least one entry prompt.

The machine learning model used here may be any suitable trained machine learning model, which may be based on any suitable model structure, including but not limited to any suitable model such as a Transformer model, a convolutional neural network (CNN), a recurrent neural network (RNN), a deep neural network (DNN), and the like. In some embodiments, the machine learning model may be a language model (LM). If the at least one machine learning model includes a plurality of machine learning models, the plurality of machine learning models may be the same, partially different, or completely different. The machine learning model used is a content generation model, which is capable of generating a corresponding output based on a model input. In some embodiments, the machine learning model based on the language model is capable of receiving the model input in a natural language and/or a machine language, and is capable of generating the desired output according to the indication of the input and the prompt.

The prompt input is used to guide the corresponding machine learning model to generate a prompt related to the service information of the target service to be entered. The prompt input may at least include a description or indication of the target service, a generation requirement of the prompt to be entered, a method of using model input information, and the like. Through such a prompt input, the machine learning model can better know the user's needs, thereby generating entry prompts that are more in line with expectations.

In some embodiments, the intelligent assistance system 220 may further enable the machine learning model to determine the entry prompt associated with the entry item based on the entry information corresponding to the entry item, in response to a certain entry item in the at least one entry item including the corresponding entry information. The entry information included in the entry item may be entry information input by the user or selection entry information selected by the user. For example, the intelligent assistance system 220 may determine the entry prompt associated with the entry item based on the entry information included in the entry item, the feature information associated with the target service, and the service recommendation information corresponding to the service type to which the target service belongs.

The intelligent assistance system 220 may provide (210) the obtained at least one entry prompt to the management platform 210, so that the management platform 210 may present the at least one entry prompt in association with the at least one entry item on the service information entry interface. Specifically, the management platform 210 may present candidate entry information corresponding to a first entry item in the at least one entry item in an input box corresponding to the first entry item, or may present, in or around a second entry item in the at least one entry item, a suggestion or a selectable adjustment option corresponding to the second entry item.

For instance, the at least one entry prompt may include candidate entry information recommended for the entry item. For example, if the entry item is a shooting style, the at least one entry prompt may include candidate entry information recommended for the shooting style (for example, styles C\D\E). For example, the management platform 210 may present the candidate entry information in a gray font in the input box corresponding to the entry item. The at least one entry prompt may also include a suggestion for the entry information in the entry item. Still taking the entry item as the shooting style as an example, the at least one entry prompt may include a suggestion for the entry information in the shooting style. The suggestion for the entry information may include, for example, a suggestion of what information to enter, how to select an option, and the like. The suggestion may be presented in association with the entry item. For example, a pop-up window may be presented near the entry item, and the suggestion may be presented in the pop-up window.

In the example of FIG. 3, based on the input information for the package name, the package price, and the like, the entry prompt 310 is provided in the package introduction to automatically generate an introduction to the current package. The service provider may directly use or adjust the generated service introduction as needed. In addition, for the information entry items of the shooting city and the shooting style, the city and the style to be selected may also be automatically suggested. In some embodiments, for such a suggestion, reasons for the suggestion may also be given, for example, there is a higher user demand in these cities under the service type, or users are more interested in these styles, the competition of the shooting service in these cities or styles is lower, the recommendation efficiency of such a package price is higher, and so on. In this way, the service provider may know how to set various types of service information at the service information entry stage, which can better meet the recommendation requirements and achieve higher recommendation efficiency.

The at least one entry prompt may further include a selectable adjustment option for the entry item, where the adjustment option is selected to trigger an adjustment of the entry information in the entry item. The entry information in the entry item may be entry information that has been input by the service provider 152 or entry information corresponding to an option that has been selected. The at least one entry prompt may include, for example, an adjustment control. For example, the management platform 210 may adjust the entry information in the entry item in response to receiving a trigger operation on the adjustment control, and provide the adjusted entry information to the service provider 152.

In some embodiments, the management platform 210 may further determine entry information corresponding to the at least one entry item by detecting a user selection or user adjustment on the at least one entry prompt, and determine the service information corresponding to the target service based on the entry information corresponding to the plurality of entry items. For example, before or during the process of entering information for the target entry item, the service provider 152 may enter information or select an option based on an entry prompt matching the target entry item. The service provider 152 may also adjust the entered information or the selected option based on the entry prompt matching the target entry item. The management platform 110 may determine the adjusted entry information corresponding to the target entry item, and determine the service information corresponding to the target service based on the adjusted entry information. For example, for the entry item of “shooting style” for the shooting service, if the previous entry information is “Style A”, the entry prompt may be “The current shooting style of Style A is highly competitive and tends to be saturated, and Style B is recommended”, and the service provider 152 may change the entry information to “Style B” based on this entry prompt. The management platform 110 may determine the changed “Style B” as the entry information finally corresponding to the entry item of “shooting style”, and determine the service information of the shooting service based on this entry information.

In this way, users may choose to use or modify the generated content, and complete the information entry of the entry item more quickly. In addition, the content automatically generated by the model not only combines part of the service information currently input by the user, but also automatically considers the feature information of the target service and/or the service provider, as well as the overall adjustment factors in the recommendation platform, which may assist the service provider to enter service information with higher recommendation efficiency. The entered service information may be used to generate a recommended content item for the target service, for recommendation to a corresponding user group. In this way, the target service may be spread to more users, so that more users can know and obtain the service.

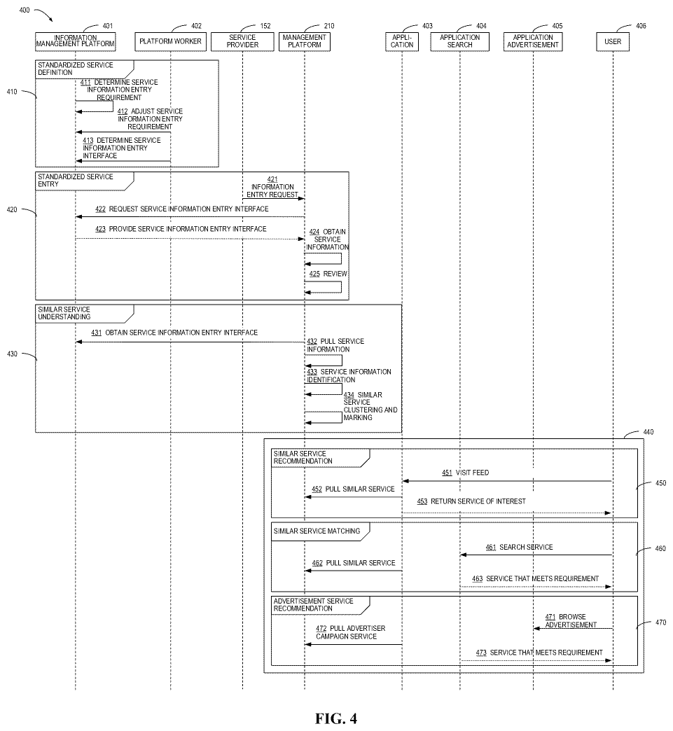

Referring to FIG. 4, FIG. 4 shows a schematic diagram of an example 400 of information interaction according to some embodiments of the present disclosure. The example 400 includes four stages which are standardized service definition 410, standardized service entry 420, similar service understanding 430, and application display 440. In the stage of standardized service definition 410, it is necessary to complete the standardized service definition at the granularity of the service type. The definition describes the basic components of a service. In the stage of standardized service entry 420, it is necessary to receive the service information of the service that can be provided by the service provider 152 entered by the service provider 152. In the stage of similar service understanding 430, the received service information is stored, and the service information is understood. Similar services may be clustered based on the understanding result. In the stage of the application display 440, a recommended content item (e.g., an advertisement) matching the service information may be provided to the user in the application.

The example 400 involves an information management platform 401, a platform worker 402, a service provider 152, a management platform 210, an application 403, an application search 404, an application advertisement 405, and a user 406. The information management platform 401 and the management platform 210 here may be deployed in the recommendation management system 150, for example.

In the stage of standardized service definition 410, the information management platform 401 may determine (411) a service information entry requirement. The platform worker 402 may adjust (412) the service information entry requirement determined by the information management platform 401, to allow the information management platform 401 to determine an adjusted service information entry requirement. The information management platform 401 may then determine (413) the service information entry interface based on the adjusted service information entry requirement.

In the stage of standardized service entry 420, the management platform 210 may receive (421) an information entry request from the service provider 152, and request (422) the service information entry interface from the information management platform 401 in response to receiving the information entry request. The information management platform 401 may provide (423) the service information entry interface to the management platform 210 in response to receiving the request. The management platform 210 may present the service information entry interface, and obtain (424) the service information entered by the service provider 152 via the service information entry interface. In some embodiments, the management platform 210 may also review (425) the service information to ensure the compliance of the service information.

In the similar service understanding 430 stage, the management platform 210 may request (431) the service information entry interface from the information management platform 401. The management platform 210 may pull (432) the service information from the service information entry interface, and perform (433) service information identification on the pulled service information. The management platform 210 may obtain a plurality of pieces of service information entered by a plurality of service providers 152. The management platform 210 may perform (434) similar service clustering and marking on the plurality of pieces of obtained service information.

The application display 440 stage may include similar service recommendation 450, similar service matching 460, and advertisement service recommendation 470. In the similar service recommendation 450, the user 406 may visit (451) a feed in the application 403. The application 403 may pull (452) a recommended content item corresponding to a service similar to the content from the management platform 210 based on the content browsed by the user 406. The application 403 may return (453) the recommended content item corresponding to the service that the user 406 may be interested in to the user 406.

In the similar service matching 460, the user 406 may use the application search 404 to search (461) for a service. The application 403 may pull (462) a recommended content item corresponding to a service similar to the service searched by the user 406 from the management platform 210. The application 403 may return (463) a recommended content item corresponding to a service that meets the requirement to the user 406 via the application search 404.

In some embodiments, in the advertisement service recommendation 470, the user 406 may browse (471) an advertisement via the application advertisement 405, which recommends a corresponding service. The application 403 may pull (472) a service recommendation from the management platform 210 that belongs to the same advertiser (e.g., the same service provider 152) as the advertisement browsed by the user. The application 403 may return (473) a recommended content item corresponding to a service that meets the requirement to the user 406 via the application search 404.

In view of the above, according to the embodiments of the present disclosure, the entry prompt may be presented in association with the entry item on the service information entry interface, which may assist the service provider to enter information more efficiently and accurately, and is helpful to improve the quality of the determined service information.

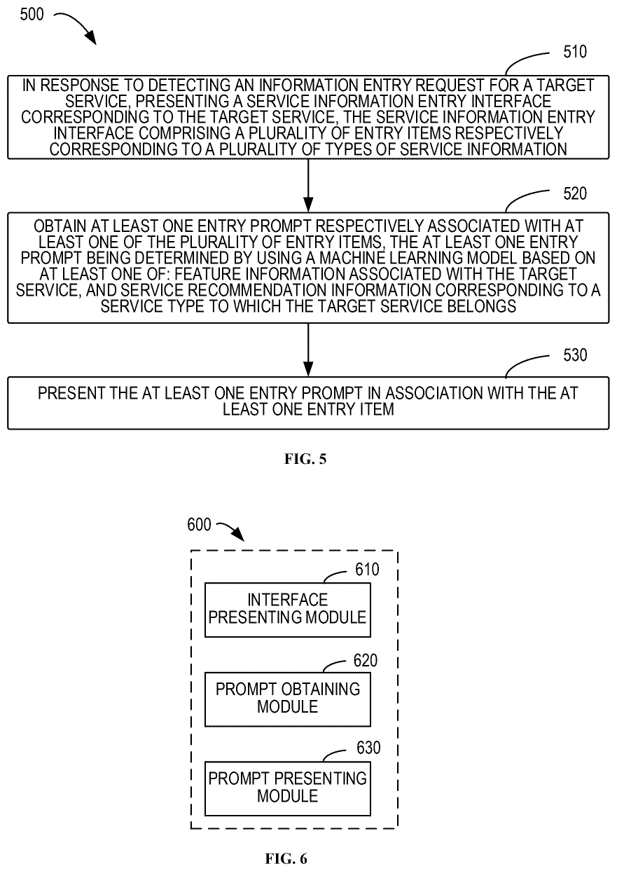

FIG. 5 shows a flowchart of a method 500 for information interaction according to some embodiments of the present disclosure. In some embodiments, the method 500 may be implemented in the recommendation management system 150. For the purpose of explanation, the method 500 will be described below from the perspective of the recommendation management system 150.

At block 510, the recommendation management system 150 presents a service information entry interface corresponding to a target service in response to detecting an information entry request for the target service, where the service information entry interface includes plurality of entry items respectively corresponding to plurality of types of service information.

At block 520, the recommendation management system 150 obtains at least one entry prompt respectively associated with at least one of the plurality of entry items, where the at least one entry prompt is determined by using a machine learning model based on at least one of: feature information associated with the target service, and service recommendation information corresponding to a service type to which the target service belongs.

At block 530, the recommendation management system 150 presents the at least one entry prompt in association with the at least one entry item.

In some embodiments, the feature information associated with the target service includes: feature information for characterizing a service provider of the target service, feature information for characterizing a service recipient of the target service, and feature information for characterizing the service type to which the target service belongs.

In some embodiments, the service recommendation information at least indicates adjustment information for the service type in a content delivery platform for recommending the target service.

In some embodiments, the at least one entry prompt includes at least one of: candidate entry information recommended for the entry item, a suggestion for the entry information in the entry item, or a selectable adjustment option for the entry item, where the adjustment option is selected to trigger an adjustment of the entry information in the entry item.

In some embodiments, presenting the at least one entry prompt in association with the at least one entry item includes: presenting, in an input box corresponding to a first entry item in the at least one entry item, the candidate entry information corresponding to the first entry item, or presenting, in or around a second entry item in the at least one entry item, the suggestion or the selectable adjustment option corresponding to the second entry item.

In some embodiments, obtaining the at least one entry prompt respectively associated with the at least one of the plurality of entry items includes: enabling the machine learning model to further determine the entry prompt associated with a third entry item based on entry information corresponding to the third entry item, in response to the third entry item in the at least one entry item including the corresponding entry information.

In some embodiments, the method 500 further includes: determining entry information corresponding to the at least one entry item by detecting a user selection or user adjustment on the at least one entry prompt; and determining the service information corresponding to the target service based on the entry information corresponding to the plurality of entry items.

In some embodiments, the service information entry interface is generated based on an interface template corresponding to a service type of the target service.

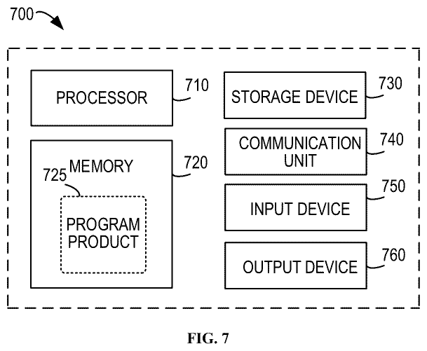

FIG. 6 shows a schematic structural block diagram of an apparatus 600 for information interaction according to some embodiments of the present disclosure. The apparatus 600 may be implemented as or included in the recommendation management system 150. The individual modules/components in the apparatus 600 may be implemented in hardware, software, firmware, or any combination thereof.

As shown in the figure, the apparatus 600 includes an interface presenting module 610 configured to present a service information entry interface corresponding to a target service in response to detecting an information entry request for the target service, where the service information entry interface includes plurality of entry items respectively corresponding to plurality of types of service information. The apparatus 600 further includes a prompt obtaining module 620 configured to obtain at least one entry prompt respectively associated with at least one of the plurality of entry items, where the at least one entry prompt is determined by using a machine learning model based on at least one of: feature information associated with the target service, and service recommendation information corresponding to a service type to which the target service belongs. The apparatus 600 further includes a prompt presenting module 630 configured to present the at least one entry prompt in association with the at least one entry item.

In some embodiments, the feature information associated with the target service includes: feature information for characterizing a service provider of the target service, feature information for characterizing a service recipient of the target service, and feature information for characterizing the service type to which the target service belongs.

In some embodiments, the service recommendation information at least indicates adjustment information for the service type in a content delivery platform for recommending the target service.

In some embodiments, the at least one entry prompt includes at least one of: candidate entry information recommended for the entry item, a suggestion for the entry information in the entry item, or a selectable adjustment option for the entry item, where the adjustment option is selected to trigger an adjustment of the entry information in the entry item.

In some embodiments, the prompt presenting module 630 includes: a first presenting module configured to present, in an input box corresponding to a first entry item in the at least one entry item, the candidate entry information corresponding to the first entry item, or a second presenting module configured to present, in or around a second entry item in the at least one entry item, the suggestion or the selectable adjustment option corresponding to the second entry item.

In some embodiments, the prompt obtaining module 620 includes: a prompt determining module configured to enable the machine learning model to further determine the entry prompt associated with a third entry item based on entry information corresponding to the third entry item, in response to the third entry item in the at least one entry item including the corresponding entry information.

In some embodiments, the apparatus 600 further includes: an entry information determining module configured to determine entry information corresponding to the at least one entry item by detecting a user selection or user adjustment on the at least one entry prompt; and a service information determining module configured to determine the service information corresponding to the target service based on the entry information corresponding to the plurality of entry items.

In some embodiments, the service information entry interface is generated based on an interface template corresponding to a service type of the target service.

The units and/or modules included in the apparatus 600 may be implemented in various ways, including software, hardware, firmware, or any combination thereof. In some embodiments, one or more units and/or modules may be implemented using software and/or firmware, such as machine-executable instructions stored on a storage medium. In addition to or as an alternative to the machine-executable instructions, some or all of the units and/or modules in the apparatus 600 may be implemented, at least in part, by one or more hardware logic components. By way of example and not limitation, exemplary types of hardware logic components that may be used include a field programmable gate array (FPGA), an application specific integrated circuit (ASIC), an application specific standard product (ASSP), a system on chip (SOC), a complex programmable logic device (CPLD), and the like.

It should be understood that one or more steps in the above methods may be performed by a suitable electronic device or a combination of electronic devices. Such an electronic device or a combination of electronic devices may include, for example, the recommendation management system 150 in FIG. 1.

FIG. 7 shows a block diagram of an electronic device 700 in which one or more embodiments of the present disclosure can be implemented. It should be understood that the electronic device 700 shown in FIG. 7 is only exemplary, and should not constitute any limitation on the function and scope of the embodiments described herein. The electronic device 700 shown in FIG. 7 may be used to implement the client device 130, or the content delivery platform 110, the recommendation conversion component 140, and/or the recommendation management system 150 (or various components therein). The electronic device 700 may include or be implemented as the apparatus 600 in FIG. 6.

As shown in FIG. 7, the electronic device 700 is in the form of a general-purpose computing device. The components of the electronic device 700 may include but are not limited to one or more processors or processing units 710, a memory 720, a storage device 730, one or more communication units 740, one or more input devices 750, and one or more output devices 760. The processor 710 may be an actual or virtual processor and can perform various processing according to a program stored in the memory 720. In a multi-processor system, a plurality of processing units execute computer-executable instructions in parallel to improve the parallel processing capability of the electronic device 700.

The electronic device 700 typically includes a plurality of computer storage media. Such a medium may be any available medium accessible by the electronic device 700, including but not limited to volatile and non-volatile media, and removable and non-removable media. The memory 720 may be a volatile memory (e.g., a register, a cache, a random access memory (RAM)), a non-volatile memory (e.g., a read-only memory (ROM), an electrically erasable programmable read-only memory (EEPROM), a flash memory), or a combination thereof. The storage device 730 may be a removable or non-removable medium and may include a machine-readable medium such as a flash drive, a magnetic disk, or any other medium that may be used to store information and/or data (e.g., training data for training) and may be accessed within the electronic device 700.

The electronic device 700 may further include additional removable/non-removable, volatile/non-volatile storage media. Although not shown in FIG. 7, a magnetic disk drive for reading from or writing to a removable, non-volatile magnetic disk (such as a “floppy disk”) and an optical disk drive for reading from or writing to a removable, non-volatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 enables communication with other electronic devices through a communication medium. Additionally, the functions of the components of the electronic device 700 may be implemented in a single computing cluster or a plurality of computing machines that can communicate through a communication connection. Therefore, the electronic device 700 may operate in a networking environment using a logical connection to one or more other servers, a network personal computer (PC), or another network node.

The input device 750 may be one or more input devices, such as a mouse, a keyboard, a trackball, and the like. The output device 760 may be one or more output devices, such as a display, a speaker, a printer, and the like. The electronic device 700 may also communicate with one or more external devices (not shown) through the communication unit 740 as needed, such as a storage device, a display device, etc., communicate with one or more devices that enable the user to interact with the electronic device 700, or communicate with any device (e.g., network card, modem, etc.) that enables the electronic device 700 to communicate with one or more other electronic devices. Such communication may be performed via an input/output (I/O) interface (not shown).

According to an exemplary implementation of the present disclosure, a computer-readable storage medium is provided, on which computer-executable instructions are stored, where the computer-executable instructions, when executed by a processor, implement the above-described method. According to an exemplary implementation of the present disclosure, there is further provided a computer program product, which is tangibly stored on a non-transitory computer-readable medium and includes computer-executable instructions, and the computer-executable instructions, when executed by a processor, implement the above-described method.

Various aspects of the present disclosure are described herein with reference to flowcharts and/or block diagrams of methods, apparatus, devices and computer program products implemented according to the present disclosure. It should be understood that each block of the flowcharts and/or block diagrams and combinations of blocks in the flowcharts and/or block diagrams may be implemented by computer-readable program instructions.

The computer-readable program instructions may be provided to a processor of a general-purpose computer, a special-purpose computer, or other programmable data processing apparatus to produce a machine, such that the instructions, when executed by the processor of the computer or other programmable data processing apparatus, produce an apparatus for implementing the functions/acts specified in one or more blocks of the flowcharts and/or block diagrams. The computer-readable program instructions may also be stored in a computer-readable storage medium, and the instructions cause the computer, the programmable data processing apparatus and/or other devices to work in a specific manner, so that the computer-readable medium storing the instructions includes an article of manufacture, which includes instructions for implementing various aspects of the functions/acts specified in one or more blocks of the flowcharts and/or block diagrams.

The computer-readable program instructions may be loaded onto a computer, other programmable data processing apparatus, or other devices, such that a series of operational steps are performed on the computer, the other programmable data processing apparatus or the other devices to produce a computer-implemented process, such that the instructions executed on the computer, the other programmable data processing apparatus or the other devices implement the functions/acts specified in one or more blocks in the flowcharts and/or block diagrams.

The flowcharts and block diagrams in the drawings show possible architecture, functionality and operation of the system, method and computer program product according to a plurality of implementations of the present disclosure. In this regard, each block in the flowcharts or block diagrams may represent a module, a program segment or part of instructions, and the module, the program segment or the part of instructions contains one or more executable instructions for implementing specified logical functions. In some alternative implementations, the functions marked in the blocks may also occur in a different order than the order marked in the drawings. For example, two blocks shown in succession may, in fact, be executed substantially concurrently, or the blocks may sometimes be executed in a reverse order, depending upon the functionality involved. It is also noted that each block of the block diagrams and/or flowcharts and combinations of blocks in the block diagrams and/or flowcharts may be implemented by a dedicated hardware-based system that performs the specified functions or acts, or may also be implemented by a combination of dedicated hardware and computer instructions.

The implementations of the present disclosure have been described above, and the above description is exemplary, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical applications or the improvements to the technology in the market, or to enable other ordinary skilled in the art to understand the implementations disclosed herein.

1. A method for information interaction, comprising:
in response to detecting an information entry request for a target service, presenting a service information entry interface corresponding to the target service, the service information entry interface comprising a plurality of entry items respectively corresponding to a plurality of types of service information;
obtaining at least one entry prompt respectively associated with at least one of the plurality of entry items, the at least one entry prompt being determined by using a machine learning model based on at least one of: feature information associated with the target service, and service recommendation information corresponding to a service type to which the target service belongs; and
presenting the at least one entry prompt in association with the at least one entry item.

2. The method of claim 1, wherein the feature information associated with the target service comprises:
feature information for characterizing a service provider of the target service,
feature information for characterizing a service recipient of the target service, and
feature information for characterizing the service type to which the target service belongs.

3. The method of claim 1, wherein the service recommendation information at least indicates adjustment information for the service type in a content delivery platform for recommending the target service.

4. The method of claim 1, wherein the at least one entry prompt comprises at least one of:
candidate entry information recommended for the entry item,
a suggestion for entry information in the entry item, or
a selectable adjustment option for the entry item, the adjustment option being selected to trigger an adjustment of the entry information in the entry item.

5. The method of claim 4, wherein presenting the at least one entry prompt in association with the at least one entry item comprises:
presenting, in an input box corresponding to the first entry item in the at least one entry item, candidate entry information corresponding to the first entry item, or
presenting, in or around a second entry item in the at least one entry item, a suggestion or a selectable adjustment option corresponding to the second entry item.

6. The method of claim 4, wherein obtaining the at least one entry prompt respectively associated with the at least one of the plurality of entry items comprises:
in response to a third entry item in the at least one entry item comprising the corresponding entry information, enabling the machine learning model to further determine an entry prompt associated with the third entry item based on entry information corresponding to the third entry item.

7. The method of claim 1, further comprising:
determining entry information corresponding to the at least one entry item by detecting a user selection or user adjustment on the at least one entry prompt; and
determining service information corresponding to the target service based on the entry information corresponding to the plurality of entry items.

8. The method of claim 1, wherein the service information entry interface is generated based on an interface template corresponding to a service type of the target service.

9. An electronic device, comprising:
at least one processor; and
at least one memory coupled to the at least one processor and storing instructions executable by the at least one processor, the instructions, when executed by the at least one processor, causing the electronic device to perform acts comprising:
in response to detecting an information entry request for a target service, presenting a service information entry interface corresponding to the target service, the service information entry interface comprising a plurality of entry items respectively corresponding to a plurality of types of service information;
obtaining at least one entry prompt respectively associated with at least one of the plurality of entry items, the at least one entry prompt being determined by using a machine learning model based on at least one of: feature information associated with the target service, and service recommendation information corresponding to a service type to which the target service belongs; and
presenting the at least one entry prompt in association with the at least one entry item.

10. The electronic device of claim 9, wherein the feature information associated with the target service comprises:
feature information for characterizing a service provider of the target service,
feature information for characterizing a service recipient of the target service, and
feature information for characterizing the service type to which the target service belongs.

11. The electronic device of claim 9, wherein the service recommendation information at least indicates adjustment information for the service type in a content delivery platform for recommending the target service.

12. The electronic device of claim 9, wherein the at least one entry prompt comprises at least one of:
candidate entry information recommended for the entry item,
a suggestion for entry information in the entry item, or
a selectable adjustment option for the entry item, the adjustment option being selected to trigger an adjustment of the entry information in the entry item.

13. The electronic device of claim 12, wherein presenting the at least one entry prompt in association with the at least one entry item comprises:
presenting, in an input box corresponding to the first entry item in the at least one entry item, candidate entry information corresponding to the first entry item, or
presenting, in or around a second entry item in the at least one entry item, a suggestion or a selectable adjustment option corresponding to the second entry item.

14. The electronic device of claim 12, wherein obtaining the at least one entry prompt respectively associated with the at least one of the plurality of entry items comprises:
in response to a third entry item in the at least one entry item comprising the corresponding entry information, enabling the machine learning model to further determine an entry prompt associated with the third entry item based on entry information corresponding to the third entry item.

15. The electronic device of claim 9, wherein the acts further comprise:
determining entry information corresponding to the at least one entry item by detecting a user selection or user adjustment on the at least one entry prompt; and
determining service information corresponding to the target service based on the entry information corresponding to the plurality of entry items.

16. The electronic device of claim 9, wherein the service information entry interface is generated based on an interface template corresponding to a service type of the target service.

17. A non-transitory computer-readable storage medium storing a computer program executable by a processor to implement acts comprising:
in response to detecting an information entry request for a target service, presenting a service information entry interface corresponding to the target service, the service information entry interface comprising a plurality of entry items respectively corresponding to a plurality of types of service information;
obtaining at least one entry prompt respectively associated with at least one of the plurality of entry items, the at least one entry prompt being determined by using a machine learning model based on at least one of: feature information associated with the target service, and service recommendation information corresponding to a service type to which the target service belongs; and
presenting the at least one entry prompt in association with the at least one entry item.

18. The non-transitory computer-readable storage medium of claim 17, wherein the feature information associated with the target service comprises:
feature information for characterizing a service provider of the target service,
feature information for characterizing a service recipient of the target service, and
feature information for characterizing the service type to which the target service belongs.

19. The non-transitory computer-readable storage medium of claim 17, wherein the service recommendation information at least indicates adjustment information for the service type in a content delivery platform for recommending the target service.

20. The non-transitory computer-readable storage medium of claim 17, wherein the at least one entry prompt comprises at least one of:
candidate entry information recommended for the entry item,
a suggestion for entry information in the entry item, or
a selectable adjustment option for the entry item, the adjustment option being selected to trigger an adjustment of the entry information in the entry item.
